(19) United States
(12) Patent Application Publication
(10) Pub. No.: US 2014/0246873 A1
(43) Pub. Date: Sep. 4, 2014

(54) MOTOR-VEHICLE DOOR HANDLE

(71) Applicants: Sebastian Raulin, Essen (DE); Stefan Neuhoff, Essen (DE); Yong Sang Cho, Seoul (KR)

(72) Inventors: Sebastian Raulin, Essen (DE); Stefan Neuhoff, Essen (DE); Yong Sang Cho, Seoul (KR)

(73) Assignee: HUF HULSBECK & FURST GMBH & CO. KG, Velbert (DE)

(21) Appl. No.: 14/009,238

(22) PCT Filed: Apr. 12, 2012
(86) PCT No.: PCT/EP12/56671

§ 371 Date: Oct. 1, 2013

(30) Foreign Application Priority Data
Apr. 15, 2011 (DE) 10 2011 002 105.1

(51) Int. Cl. E05B 81/64

(52) U.S. Cl. CPC E05B 81/64
USPC 292/336.3

(57) ABSTRACT

A motor-vehicle door handle includes at least one electronics subassembly and a first sensor electrode for a first capacitive sensor for triggering an unlocking operation when an approach to a grasping area is sensed. The sensor electrode is connected to the electronics subassembly. In known motor-vehicle door handles, the sensor electrode is arranged within the electronics module a) over a large surface area and b) always adjacent to the grasping area. For the instant motor-vehicle door handle there is improved flexibility in respect of position and configuration of the electronics module. This is achieved by the first sensor electrode being, in part, led out of the electronics module, that part of the sensor electrode which is led out having a portion which is arranged adjacent to the grasping area in the motor-vehicle door handle such that an approach to the grasping area can be sensed.

The invention relates to a motor vehicle door handle with a wall surrounding at least one cavity and a gripping region, wherein the wall has an inwardly directed wall section, which, together with a door associated with the motor vehicle door handle, defines an engagement space, and an outwardly directed wall section, an electronic module arranged in the at least one cavity, wherein the electronic module includes at least one electronic assembly and completely encloses it, and with a first sensor electrode of a first capacitive sensor for initiating an unlocking process on detection of an approach to the engagement space, wherein the sensor electrode is electrically connected to the electronic assembly.

In known motor vehicle door handles of the type referred to above, the electronic module is constructed so that it extends nearly over the entire length of the inwardly directed wall section, along the entire gripping region of the motor vehicle door handle. Arranged in the sensor module adjacent to the inwardly directed wall section there is a first sensor electrode in order to enable the detection of an approach to the engagement space. In order to ensure uniform detection over the entire engagement space, the entire length of the gripping region of the motor vehicle door handle, and thus a high ease of use, this first sensor electrode and thus the electronic module extends nearly over the entire length of the gripping region. Such a construction of the electronic module necessitates it being matched to different differently designed constructions of a motor vehicle door handle and always takes up a large space in the motor vehicle door handle.

It is the objection of the present patent application to increase the flexibility as regards the arrangement of the electronic module in the motor vehicle door handle with the convenience to the user remaining unchanged. This object is solved in accordance with the invention by a motor vehicle door handle in accordance with claim 1.

In accordance with the invention, the motor vehicle door handle of the type referred to above is characterised in that the first sensor electrode extends in part out of the electronic module, wherein the extending portion of the sensor electrode has a section, which is arranged in the motor vehicle door handle adjacent the inwardly directed wall section, such that an approach to the engagement space can be detected. In the motor vehicle door handle in accordance with the invention, the sensor electrode is thus not wholly arranged within the electronic module and instead a portion of the sensor electrode extends out of the electronic module for positioning in the motor vehicle door handle. With a motor vehicle door handle constructed in this manner, the positioning of the electronic module in the motor vehicle door handle is flexible, the electronic module need not be arranged in the motor vehicle door handle adjacent the inwardly directed wall section in order to be able to detect an approach to the engagement space since the portion of the first sensor electrode extending out of the electronic module takes on this function. The extending portion of the first sensor electrode extends the operative region of the capacitive sensor beyond the electronic module so that the operative area of the first capacitive sensor can be maintained over the entire gripping length of the motor vehicle door handle with an appropriate arrangement of the extending portion of the sensor electrode so that the ease of use is not limited even though the flexibility as regards the design and the arrangement of the electronic module is greatly increased.

The electronic assembly in the electronic module includes, amongst other things, a printed circuit board, on which are arranged the components of an electronic evaluation unit and which analyses the signals detected by the first electrode and transmits them to a control unit in, for instance, the motor vehicle door.

In a motor vehicle door handle in accordance with the invention, a standard electronic module can be used which can also be used in other types of motor vehicle door handles, whereby the production costs for the motor vehicle door handle decrease since an individual electronic module need not be made for each special motor vehicle door handle. The extension and arrangement of a portion of the first sensor electrode of the motor vehicle door handle in accordance with the invention also renders it possible to make the electronic module as such considerably smaller, which contributes to a reduction in the production costs of the entire motor vehicle door handle.

The motor vehicle door handle in accordance with the invention can include a second sensor, and particularly a second capacitive sensor with a second sensor electrode, for initiating a locking process, wherein the second sensor is electrically connected to the electronic assembly. In the event of a capacitive sensor, at least one section of the second sensor electrode of the sensor is arranged adjacent the outwardly directed wall section such that an approach to a position on the wall section associated with the section of the second sensor electrode can be detected. The term “outwardly directed wall section” is not to be limited in the context of this invention to the wall section of the motor vehicle door handle, which is substantially opposed to the inwardly directed wall section, which, together with the door associated with the motor vehicle door handle, defines an engagement space. The term is instead to extend also to the upwardly and downwardly directed regions of the motor vehicle door handle so that the section of the second sensor electrode can also be arranged in the upper or lower region of the motor vehicle door handle such that an approach to a position associated with the section “from below” and “from above” can be detected. With such a motor vehicle door handle, the electronic assembly in the electronic module also includes the electronic evaluation unit for detecting the locking.

In a preferred embodiment, the second sensor electrode is wholly arranged within the electronic module and the cavity is formed in the motor vehicle door handle adjacent the outwardly directed wall section and the electronic module is arranged near the outwardly directed wall section, wherein the section of the second sensor electrode is arranged in the electronic module such that an approach to a position, associated with the section of a second sensor electrode, near the outwardly directed wall section can be detected. Such a construction of the motor vehicle door handle determines the design of the electronic module and its arrangement so that as a result of the positioning of the electronic module within the motor vehicle door handle the desired position of at least a section of the second sensor electrode is ensured. The arrangement of the second sensor electrode within the electronic module protects it from environmental influences and ensures decoupling with respect to the first sensor electrode.

In a design referred to above of the motor vehicle door handle with two sensors, it can include a cavity, which is disposed near or adjacent to the inwardly directed wall section and is connected to the first cavity and in which the section of the first sensor electrode is disposed, wherein the arrangement of the first sensor electrode is effected such that an approach to the engagement space can be detected. As a result of the provision of a second cavity, a spatial separation of the electronic module and the portion of the first sensor electrode extending out of the electronic module is ensured, whereby the decoupling of the two sensor electrodes is improved. The cavities can additionally be made smaller, which contributes to an increase in the stability of the motor vehicle door handle and leaves more space for further assemblies.

Alternatively, the second sensor electrode can extend in part out of the electronic module, wherein the extending portion of the second sensor electrode has a section, which is disposed adjacent to the outwardly directed wall section such that an approach to the position on the wall section associated with the section of the sensor electrode can be detected. In this exemplary embodiment of the motor vehicle door handle in accordance with the invention, both a section of the first and also of the second sensor electrode extends out of the electronic module, which further increases the flexibility as regards the arrangement of the electronic module in the motor vehicle door handle. As a result of a such a design of the motor vehicle door handle in accordance with the invention, it is further possible to keep the structural size of the electronic module small.

In a particularly preferred exemplary embodiment of the motor vehicle door handle in accordance with the invention, the portion of the first sensor electrode and/or the second sensor electrode extending out of the electronic module is of flexible construction, at least in sections. A motor vehicle door handle constructed in this manner is particularly flexible as regards the positioning of the electronic module in the motor vehicle door handle since the extending portions of the first and/or the second sensor electrode can be arranged in it matched to the shape of the motor vehicle door handle.

The flexible portion of the first and/or second sensor electrode extending out of the electronic module can, for instance, be a simple and optionally sheathed wire. It is, however, preferred that the portion of the first sensor module and/or the second sensor module extending out of the electronic module extends back into the electronic module in the form of a loop and is connected in it to the electronic assembly. This has the advantage that the projecting portion of the first and/or second sensor electrode has no “open” end and thus no further steps are necessary in order to protect the projecting portion of the first and/or second sensor electrode against environmental influences.

Alternatively, the projecting portion of the first and/or second sensor electrode can be constructed in the form of a stampable, bendable or cuttable metal plate in order to ensure the possibility of matching to the interior of the motor vehicle door handle or the cavity or cavities situated in it.

The electronic module encasing the electronic assembly can, for instance, be constructed so that it is provided by insert moulding or encapsulation of the electronic assembly. Providing the electronic module in this manner is, however, complex as regards manufacturing technology since the electronic assembly must be inserted into an appropriate mould before it is encapsulated or the injection moulding is performed. It is therefore preferred that the electronic assembly may be slid into the electronic module, preferably at an end surface, the electronic module is provided in the form of a type of a container, into which the electronic assembly may be inserted. This has the advantage that a standard container can be used, into which different electronic assemblies can be introduced, depending on requirements as regards, for instance, the sensor system for locking and unlocking. The electronic module as such already constitutes protection of the electronic assembly against environmental influences. In order to further increase such protection, in a preferred exemplary embodiment of the motor vehicle door handle, the interior of the container of the electronic module is filled with a potting composition, which protects the electronic assembly against environmental influences and fixes it in the container.

The invention will be explained below in more detail with reference to a number of preferred exemplary embodiments illustrated in the drawings, in which:

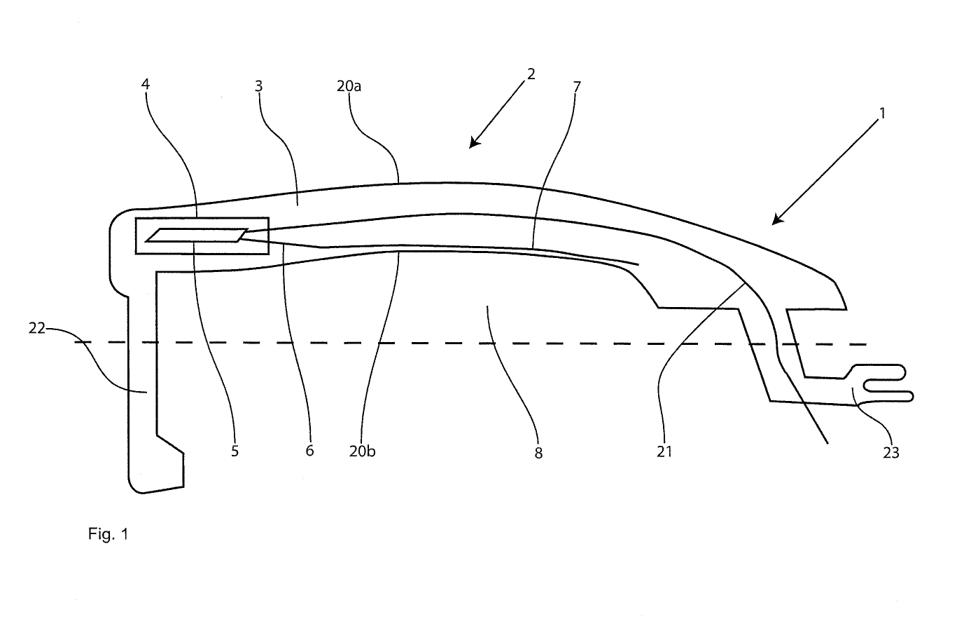

FIG. 1 is a schematic sectional view of an exemplary embodiment of the motor vehicle door handle in accordance with the invention.

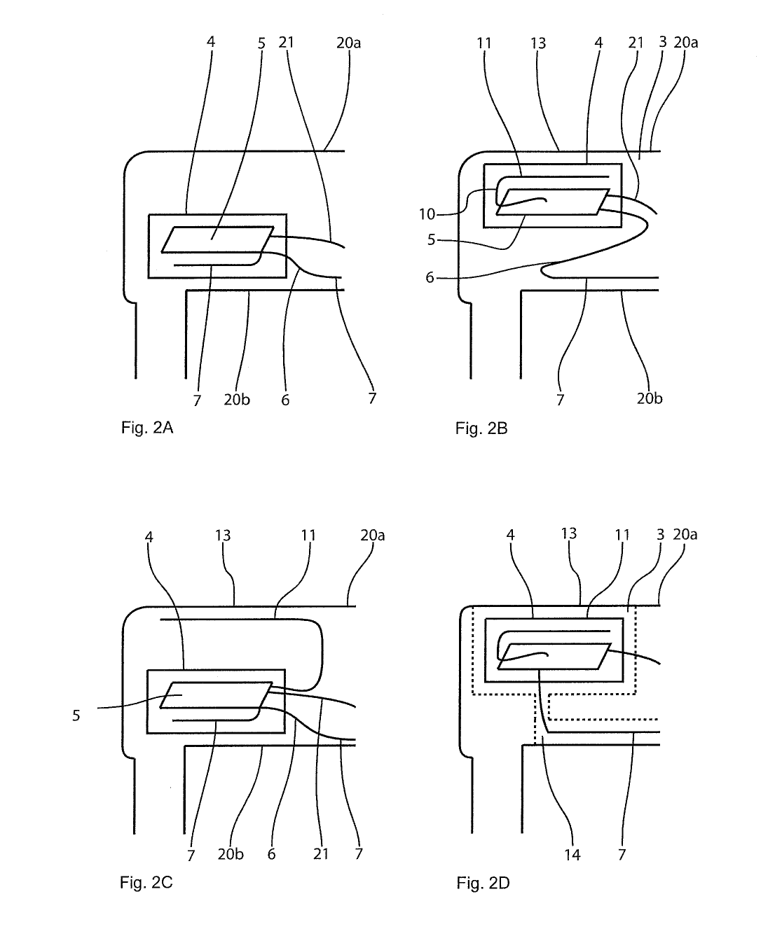

FIGS. 2A-2D are schematic partial sectional views of a number of exemplary embodiments of the motor vehicle door handle in accordance with the invention.

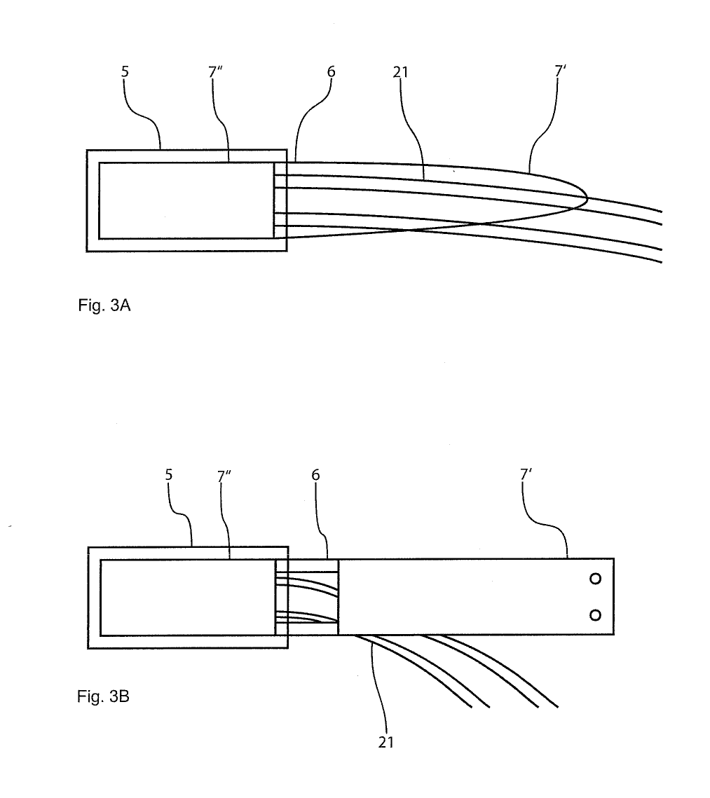

FIGS. 3A and 3B show different embodiments of the electronic module, and

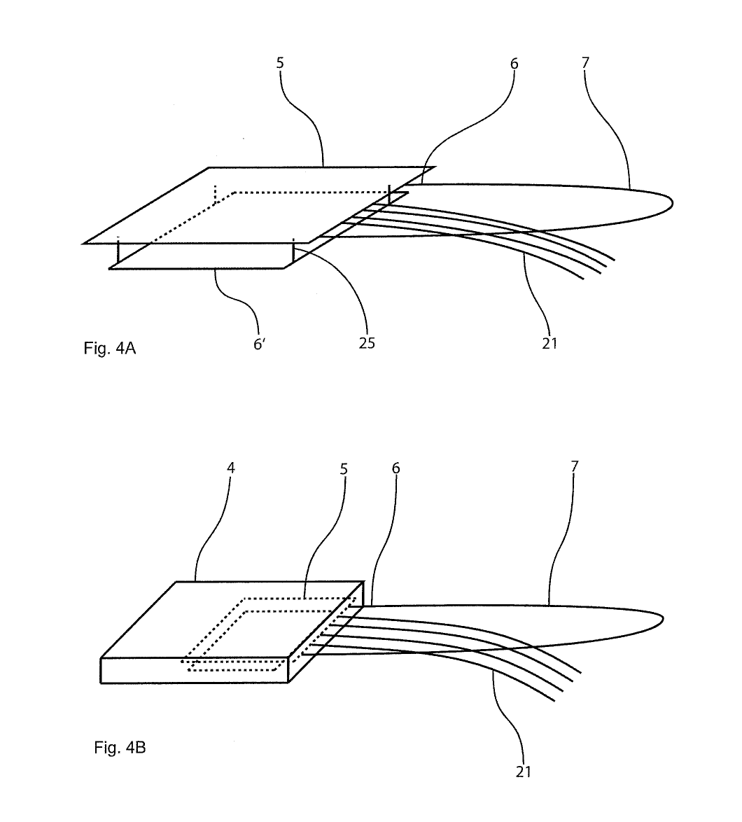

FIG. 4A is a side view of the assembly of an exemplary embodiment of the motor vehicle door handle in accordance with the invention and FIG. 4B is a side view of the electronic module of a further exemplary embodiment of the motor vehicle door handle in accordance with the invention.

FIG. 1 is a schematic sectional view of an exemplary embodiment of the motor vehicle door handle 1 in accordance with the invention with a gripping region 2, a handle fastening region 22 and a pivotal region 23. The wall of the motor vehicle door handle 1 in the exemplary embodiment illustrated in FIG. 1 surrounds a cavity 3, wherein, for the sake of simplicity, the cavity 3 is not defined spatially in detail in the illustrated exemplary embodiment. It is in general the case that conventional components of a motor vehicle door handle, which are not of importance for the present invention, have been omitted for the benefit of clarity from the purely schematic views of the different exemplary embodiments of the motor vehicle door handle in accordance with the invention. The wall of the motor vehicle door handle 1 includes a wall section 20b, which, together with a door associated with the motor vehicle door handle 1, which is indicated in FIG. 1 by a chain line, defines an engagement space 8, and an outwardly directed wall section 20a.

Disposed in the cavity 3 is an electronic module 4, which includes at least one electronic assembly 5, wherein the electronic assembly 5 is completely enveloped by the electronic module 4 so that the electronic module 4 protects the electronic assembly 5 from environmental influences. In the exemplary embodiment which is illustrated here, the electronic module 4 is constructed in the form of a type of container. However, in other exemplary embodiments, the electronic module can be provided by insert moulding or encapsulation of the electronic assembly 5. The illustrated exemplary embodiment of the motor vehicle door handle in accordance with the invention further includes a first sensor electrode 6 of a first capacitive sensor for initiating an unlocking process on detection of an approach to the engagement space 8. This sensor electrode 6 is electrically connected to the electronic assembly 5. A segment of the sensor electrode extends within the electronic module 4 but the greater proportion of the sensor electrode 6 extends, however, out of the electronic module 4 and a section 7 of the extending portion is disposed in the region of the wall section 20b so that an approach of a user to the engagement space 8 can be detected by this section 7. The arrangement of the electronic module 4 in the cavity 3 in the motor vehicle door handle 1 is not crucial in the illustrated exemplary embodiment; of importance, on the other hand, is the arrangement of the section 7 along or adjacent to the wall section 20b, since this arrangement essentially enables the detection of an approach. In order to maintain the ease of use as high as possible, the section 7 of the first sensor electrode 6 is arranged substantially along the entire wall section 20b of the engagement region. Also connected to the electronic assembly 5 in the electronic module 4 are supply wires 21, which extend within the motor vehicle door handle 1, wherein they exit from the interior of the motor vehicle door handle near the pivotal region 23 and are coupled to a voltage supply and a control device (both not illustrated) in the interior of the motor vehicle. The electronic assembly 5 includes, amongst other things, a circuit board with components of an analysis circuit of the first capacitive sensor.

FIGS. 2A to 2D are schematic, partial sectional views of different exemplary embodiments of the motor vehicle door handle in accordance with the invention. In the exemplary embodiment shown in FIG. 2A, the electronic module 4 is arranged in the vicinity of or adjacent to the wall section 20b. The first sensor electrode 6 includes a section 7′, which, corresponding to the exemplary embodiment shown in FIG. 1, is arranged along the wall section 20b of the gripping region 2. Furthermore, the first sensor electrode 6 includes a further section 7″, which is arranged within the electronic module 4, specifically below the electronic assembly 5. Such a design has the advantage that an approach can be detected also in the vicinity of the electronic module 4 itself.

In the exemplary embodiment shown in FIG. 2B, the electronic module 4 includes a second capacitive sensor with a second sensor electrode 10 for initiating a locking process. The second capacitive sensor is wholly contained within the electronic assembly 4, the second sensor electrode 10 is also completely contained within the electronic module 4 and does not extend out of it. The second sensor electrode 10 includes a section 11, which is arranged to the adjacent to the upper wall of the electronic module 4 and this is in turn arranged adjacent to the wall section 20a of the wall of the motor vehicle door handle so that an approach to the portion 13, associated with this section 11, of the wall section 20a, can be detected by means of the section 11 of the sensor electrode 10. In contrast to the section 7 of the first sensor electrode, the section 11 of the second sensor electrode operates merely locally on the portion 13, associated with the section 1, of the wall section 20a. In the exemplary embodiment shown in FIG. 2B, the first sensor electrode 7 includes no section arranged beneath the electronic assembly 5 so that the section 7 of the sensor electrode is arranged slightly differently in the cavity 3 of the motor vehicle door handle 1 in order to ensure detection over the entire length of the wall section 20b.

In the exemplary embodiment shown in FIG. 2C, a portion of the second sensor electrode 10 extends out of the electronic module 4. Due to the function of the second sensor electrode, namely the detection of an approach to a portion of the outer wall or the wall section 20a, a section 11 of the second sensor electrode is arranged adjacent a portion 13 of the wall section 20a. In the exemplary embodiment illustrated in FIG. 2C, the first sensor electrode 6 of the first capacitive sensor again includes two sections 7′ and 7″, wherein the section 7″ is arranged below the electronic assembly. In order that this section can detect an approach to the engagement space 8, the electronic module 4 is arranged near the wall section 20b, that is to say the wall section directed towards the engagement space 8, in the illustrated exemplary embodiment.

In the exemplary embodiment shown in FIG. 2D, the electronic assembly 4 again includes a first and second capacitive sensor, wherein the second capacitive sensor is wholly contained within the electronic module 4 so that arrangement of the electronic module 4 on the wall section 20a is necessary. The electronic module 4 is arranged in the first cavity 3. The motor vehicle door handle 1 in the illustrated exemplary embodiment includes a second cavity 14, which is connected to the first cavity 3, and the section 11 of the first sensor electrode 6 is arranged in the second cavity 14 and is responsible for detecting an approach to the engagement space 8. The spatial separation of the sections 11 and 7 of the first and second sensor electrodes causes a particularly good decoupling of the two electrode sections.

FIG. 3A is a schematic view of the underside of the electronic assembly 5 of an exemplary embodiment of the invention. Attached to the underside of the electronic assembly 5 is a section 7″ of the first sensor electrode 6. A second section 7′ extends away from the electronic assembly 5 and in the event that the illustrated electronic assembly 5 is inserted into an electronic module 4, would project out of it. The section 7′ is constructed in the illustrated exemplary embodiment in the form of a loop, the section 7′ extends back to the electronic assembly 5. The electronic assembly 5 further includes four supply leads 21 which are responsible for a power supply and signal transmission into the interior of the motor vehicle.

In the exemplary embodiment shown in FIG. 3B, the region 7′ of the first sensor electrode is constructed in the form of a metal plate, wherein this has two retaining means 24, with which the section 7′ of the first sensor electrode can be fixed in position in the motor vehicle door handle. In the exemplary embodiment illustrated here the retaining means 24 are constructed in the form of openings in the section 7′.

FIG. 4A is a side view of the electronic assembly 5 of a of a further exemplary embodiment of the motor vehicle door handle in accordance with the invention. Connected to the electronic assembly 5 is a first sensor electrode 6 with a section 7, which, in the installed state of the electronic assembly 5, detects an approach to the engagement space 8. Arranged beneath the electronic assembly 5 is a second first electrode 6′, which is not directly electrically connected to the first electrode 6, the sensor electrode 6′ is a part of a further capacitive sensor. In the illustrated exemplary embodiment, the electrode 6′ below the assembly 5 is connected to it via four supply lines 21. In a corresponding exemplary embodiment, the electronic module 4 should be arranged adjacent to the outer wall section 20b. The analysis of the signals detected at the first electrodes 6′ and 6 can be effected in the same or separate evaluation circuits. The construction of the first electrode, that is to say the electrode which detects an approach to the engagement space 8, in the form of a dual or doubled first electrode results in a certain redundancy as regards detection at the engagement space 8, i.e. in the event of failure of the first electrode 6 an approach can still be detected via the first electrode 6′, though the ease of use in such an event is significantly reduced.

FIG. 4B is a side view of an electronic module 4, into which the electronic assembly 5 has been slid. The first electrode 6 with the detection section 7 is constructed in the form of a loop and a portion of this first electrode 6 extends out of the module. The electronic assembly 5 is further connected to four supply wires 21, which are responsible for power supply to the electronic assembly and transmit control signals into the interior of the motor vehicle door handle or of the motor vehicle. In the illustrated exemplary embodiment, the electronic module includes a container open at one end surface, into which the electronic assembly 5 is slid. In order to protect the electronic assembly more effectively against environmental influences, the container can be filled with a potting composition.

1. A motor vehicle door handle with at least one wall surrounding a cavity and a gripping region, wherein the wall has an inwardly directed wall section, which, together with a door associated with the motor vehicle door handle, defines an engagement space, and an outwardly directed wall section, an electronic module arranged in the at least one cavity, wherein the electronic module includes at least one electronic assembly and completely encloses it, a first sensor electrode of a first capacitive sensor for initiating an unlocking process on detection of an approach to the engagement space, wherein the sensor electrode is electrically connected to the electronic assembly, characterised in that the first sensor electrode extends in part out of the electronic module, wherein the extending portion of the sensor electrode has a section, which is arranged in the motor vehicle door handle adjacent the inwardly directed wall section such that an approach to the engagement space can be detected.

2. A motor vehicle door handle as claimed in claim 1, characterised in that the motor vehicle door handle includes a second capacitive sensor with a second sensor electrode for initiating a locking process, wherein the second sensor electrode is electrically connected to the electronic assembly and at least one section of the second sensor electrode is arranged adjacent the outwardly directed wall section such that an approach to a position of the wall section associated with the section of the second sensor electrode can be detected.

3. A motor vehicle door handle as claimed in claim 2, characterised in that the second sensor electrode is wholly disposed within the electronic module and that the cavity is formed in the motor vehicle door handle adjacent the outwardly directed wall section and the electronic module is disposed near the outwardly directed wall section, wherein the section of the second sensor electrode is so arranged in the electronic module that an approach to a position near the outwardly directed wall section and associated with the second sensor electrode can be detected.

4. A motor vehicle door handle as claimed in claim 3, characterised in that the motor vehicle door handle includes a second cavity, arranged adjacent to or near the inwardly directed wall section, which is connected to the first cavity and in which the section of the first sensor electrode is arranged such that an approach to the engagement space can be detected.

5. A motor vehicle door handle as claimed in claim 2, characterised in that the second sensor electrode extends in part out of the electronic module, wherein the extending portion of the second sensor electrode has a section, which is disposed adjacent the outwardly directed wall section such that an approach to the position on the wall section associated with the section of the sensor electrode can be detected.

6. A motor vehicle door handle as claimed in claim 1, characterised in that the section of the first sensor electrode and/or of the second sensor electrode which extends out of the electronic module is flexible, at least in sections.

7. A motor vehicle door handle as claimed in claim 6, characterised in that the portion of the first sensor electrode and/or the second electrode which extends out of the electronic module extends back into the electronic module in the form of a loop.

8. A motor vehicle door handle as claimed in claim 1, characterised in that the electronic assembly is slidable into the electronic module, preferably at an end surface.

9. A motor vehicle door handle as claimed in one of claim 1, characterised in that the portion of the first sensor electrode which extends out of the electronic module is in the form of a metal plate, wherein the metal plate is bendable, cuttable or stampable.
